(19) United States
(12) Patent Application Publication
(10) Pub. No.: US 2005/0158498 A1
(43) Pub. Date: Jul. 21, 2005

(54) Flexible tubes for fixed peripheral venous cannulas

(76) Inventor: Andreas Dolla, Hof (DE)

Correspondence Address: VENABLE LLP, P.O. BOX 34385, WASHINGTON, DC, 20045-9998, US

(21) Appl. No.: 10/513,662

(22) PCT Filed: Apr. 30, 2003
(86) PCT No.: PCT/EP03/04515

(30) Foreign Application Priority Data
May 8, 2002 (DE) 10220410.1

(51) Int. Cl. B29D 22/00

(52) U.S. Cl. 428/36.9; 604/529; 138/137

(57) ABSTRACT

The invention concerns flexible tubes for delivering solutions for perfusion or injection into the peripheral vascular system. The invention is characterized in that said flexible tubes are manufactured by coextrusion process from a composite polyamide and polyurethane laminate, the inner layer facing the lumen and the outer layer being respectively formed with polyamide and polyurethane. The desired properties of said flexible tubes, such as buckling stability, flexural rigidity or free flow capacity, can be adjusted and customized on the basis of the wall thickness distribution which, preferably has a PA/PUR ratio of 50:50 to 70:30, and on the basis of the Shore hardness of the initial constituents.

Flexible tubes for fixed peripheral venous cannulas are used in the peripheral vascular system to deliver solutions for infusions and injections as well as for taking blood. Solutions or injections are delivered or blood taken from a vein in the peripheral vascular system, meaning far from the heart, by means of a flexible tube or plastic cannula. The materials used for this according to prior art are FEP or PUR in the form of single-material flexible tubes, with or without radiopaque strips.

Several important properties of flexible tubes of FEP or PUR for fixed venous cannulas are evaluated in the following Table 1.

TABLE 1

| | | | | Ten- | | |
|---|---|---|---|---|---|---|
| | Ri- | | Advanc- | dency to | Blood | |
| Mate- | gid- | Buckling | ing | inflam- | compati- | Roll-up |
| rial | ity | resistance | ability | mation | bility | behavior |
| FEP | ++ | − | ++ | −− | − | ++ |
| PUR | + | + | + | ++ | ++ | − |

Explanattions
Rigidity=Resistance against bending as a result of radial forces;
Buckling resistance=Resistance of the flexible tube to buckle following deflection/bending around a narrow radius, so as to prevent lumen closure and/or irreversible damage to the flexible tube;
Advancing ability=Easy placement and positioning of catheter in vessels due to axial stress without resistance worth mentioning;
Roll-up behavior=Contracting and compressing tendency of the tube-shaped cannula (harmonica effect) caused by penetration of skin, tissue and the vein as a result of application and gliding resistance.

As shown in the above Table, FEP primarily distinguishes itself through an extremely good advancing ability. However, it has the disadvantage of being subject to higher incidences of buckling, which lead to interference with or even a complete stop of the throughput, as well as the strongly increased risk of injury and/or inflammation of the vascular walls.

In contrast, PUR has an acceptable buckling resistance and good blood compatibility and the risk of inflammation or injury to the vessel walls is nearly zero.

The reason for the latter is that PUR becomes soft within a few minutes at body temperature, meaning that hardly any mechanical irritation of the vascular walls occurs.

However, PUR has the particular disadvantage of a noticeably higher “roll-up” risk for the cannula during the application.

It is therefore the object of the present invention to make available flexible tubes for fixed peripheral venous cannulas which combine the positive properties of FEP with those of the PUR without also taking over the respectively negative properties (see Table 1 for this).

Surprisingly, this object was solved with a flexible tube design for fixed peripheral venous cannulas, which uses a composite laminate, comprising an inside layer of polyamide and an outside layer of polyurethane.

The considerations that went into solving this problem are described in the following:
Homo polymers are used for producing tube-shaped extruded products, wherein co-polymers or polymer mixtures are primarily used, especially in the field of medicine.

However, if the spectrum of properties for standard materials or self-formulated materials is not sufficient, composite laminates of materials having different properties are used. To be considered are cases where the inside surface of the flexible tube must have noticeably different properties than the outside surface, for example if the outside surface must have a good bonding ability and the inside surface a high chemical resistance.

The macroscopic properties of such conventional composite laminates, e.g. rigidity or bending resistance, are determined by the sum of the individual material property shares, for example as described in the following U.S. Pat. No. 4,385,632. Described in this reference is a composite laminate for an angiography catheter, provided with a soft, a-traumatic tip made exclusively from polyurethane, a transition region and a main flexible tube section consisting of an internal polyamide layer and an external layer of polyurethane with an approximate wall thickness ratio of 50:50.

It is the object of this embodiment in the form of a composite laminate is to meet the following requirements:
To have a soft, a-traumatic non-reinforced polyurethane tip;
To attach this tip firmly to the flexible catheter tube;
To ensure a correspondingly high rigidity of the catheter with low wall thickness, which is necessary since the radiopaque medium is applied with high pressure (up to 1200 psi) and a bursting of the catheter during this operation must be safely avoided.

The present invention, on the other hand, is designed to achieve the above-described flexible tube properties for tubes used as fixed venous cannulas, wherein these properties must clearly exceed the sum of the individual material properties. Such combinations of material properties should be achievable only if the systems exhibit a certain synergic effect and the materials used are furthermore precisely adapted to the respective application case.

According to one important requirement, the flexible tube should be as rigid as possible during the insertion into the body and as flexible as possible while remaining in the body. These properties, which initially seem to be mutually exclusive, can surprisingly be achieved with the material combination according to our invention. This is due to the fact that PUR with a shore hardness of 60 D, for example, softens to 50 D at 37° C. within 5 minutes. In contrast, the flexibility of PA is primarily influenced by the absorption of moisture, wherein this action is insignificant as compared to PUR and requires a longer period of time.

These in part opposing and in part super-imposed effects not only make possible—depending on the relative wall thickness of PUR to PA and the respective shore hardness of the individual materials—to precisely adjust on the one hand the required rigidity for placing the flexible tube and, on the other hand, the required flexibility necessary for remaining inside the body. Rather, it was particularly surprising that other properties necessary for using the flexible tube could also be adjusted purposely, namely the rigidity, the buckling resistance, the advancing ability, and the roll-up behavior.

With this invention, the user therefore has many options to purposely and easily influence the flexible tube properties of fixed venous cannulas, meaning so-to-speak adjust them precisely to the requirements. That is not possible with the currently used single-material flexible tubes according to prior art.

The desired properties of flexible tubes for fixed peripheral venous cannulas furthermore can in most cases be guaranteed even with fluctuations in the raw-material quality by varying the respective layer thicknesses of the co-extruded flexible tube.

The sum of all properties of the composite-material flexible tube can furthermore be changed considerably, but in a simple manner, without requiring special formula mixtures by using different, commonly used standard raw materials with different mechanical properties.

However, such formula mixtures can additionally be used and can result in a further optimization and/or a precise adjustment of the flexible tube properties.

The following Table 2 provides a summary of the properties of the composite laminate according to the invention, comprising an external PA layer and an internal PUR layer for the flexible tube, as compared to tubes made from the starting substances PA and PUR and/or FEP:

TABLE 2

| | | Buck- | | Ten- | | |
|---|---|---|---|---|---|---|
| | Ri | ling | Advanc- | dency to | Blood | |
| Mate- | gid- | resis- | ing | inflam- | compati | Roll-up |
| rial | ity | tance | ability | mation | bility | behavior |
| FEP | ++ | − | ++ | −− | − | ++ |
| PUR | + | + | + | ++ | ++ | − |
| PA | ++ | + | ++ | + | + | ++ |
| PA/PUR | ++ | ++ | ++ | ++ | ++ | ++ |

+ = good
++ = very good
− = poor
−− = very poor

The following is intended to explain with the aid of an exemplary embodiment whether the invention is suitable for use as flexible tube for a fixed peripheral venous cannula. The tested flexible tube, used as fixed peripheral venous cannula, has an external diameter of 1.07 mm, an internal diameter of 0.79 mm and is provided with radiopaque strips.

If this flexible tube with PA internal layer and PUTR external layer is deflected by 180° around a pin with 4 mm diameter, it does not buckle in the temperature range between 23° C. and 37° C.

For a comparison:
A FEP flexible tube will definitely buckle at this temperature range and will be damaged in the process, such that the throughput, for example of infusion solution, is reduced or even blocked permanently. Owing to this irreversible damage, it becomes necessary to replace the flexible tube for the fixed venous cannula, which leads to unnecessary stress for the patient, particularly if the patient has hard to puncture veins.
A PUR flexible tube does not buckle at 37° C., to be sure, but the danger of buckling at temperatures below 30° C. is rather high—depending on the wall thickness and external diameter—so that the pure PUR flexible tube has only a limited usability for fixed peripheral venous cannulas.

1. Flexible tubes made from polymers for use as fixed venous cannulas, said flexible tubes comprising a composite laminate of polyamide and polyurethane, wherein the inside layer facing the lumen is a polyamide layer and the outside layer is a polyurethane layer.

2. The flexible tubes as defined in claim 1, characterized in that the polyamide is selected from the group polyamide 11, polyamide 12 or polyetherblockamide.

3. The flexible tubes as defined in claim 1, characterized in that the polyurethane is selected from the group polyetherpolyurethane or polyesterpolyurethane.

4. The flexible tubes used for fixed peripheral venous cannulas as defined according to claim 1, characterized in that the composite laminate preferably is a coextruded material.

5. The flexible tubes used for fixed peripheral venous cannulas as defined according to claim 1, characterized in that the composite laminate has a layer thickness ratio of PA internal layer to PUR external layer ranging from 20:80 to 80:20 and preferably from 50:50 to 70:30.

6. The flexible tubes used for fixed peripheral venous cannulas as defined according to claim 1, characterized in that the internal and/or external layer is provided with one or several roadipaque strips.
